(19) United States
(12) Patent Application Publication
(10) Pub. No.: US 2017/0197509 A1
(43) Pub. Date: Jul. 13, 2017

(54) CONVERTER COMPRISING REDUNDANT SWITCH-FUSE COMBINATIONS AND METHOD FOR SELECTIVE TRIGGERING OF THE FUSE IN THE EVENT OF SWITCH FAILURE

(71) Applicant: Siemens Aktiengesellschaft, 80333 München (DE)

(72) Inventors: RAINER LEHNERT, Rohr (DE); MARKUS PFEIFER, Nürnberg (DE)

(73) Assignee: Siemens Aktiengesellschaft, 80333 München (DE)

(21) Appl. No.: 15/324,505

(22) PCT Filed: May 20, 2015
(86) PCT No.: PCT/EP2015/061129

§ 371 Date: Jan. 6, 2017

(30) Foreign Application Priority Data
Jul. 9, 2014 (DE) 10 2014 213 309.2
Apr. 14, 2015 (DE) 10 2015 206 627.4

(51) Int. Cl. B60L 11/08; H02M 5/458; H02P 31/00; H02M 1/32; H02P 27/06; B60L 11/12; H02M 1/084

(52) U.S. Cl. CPC B60L 11/08; B60L 11/12; H02M 5/458; H02M 1/084; H02M 1/32; H02P 27/06; H02P 31/00; H02M 2001/325

(57) ABSTRACT

The invention relates to a converter (1) comprising an intermediate circuit (3) for providing a DC voltage (10) between a positive conductor (11) and a negative conductor (12), a phase conductor (8, 9) for receiving and/or output of an AC voltage, and a half-bridge circuit (17) comprising a first switch arrangement (18) for connecting the positive conductor (11) to the phase conductor (8, 9) and a second switch arrangement (19) for connecting the negative conductor (12) to the phase conductor (8, 9). In case of a defect of a semiconductor switch (20, 21) of the converter (1), the converter (1) is to be able to protect itself and continue to operate. For this purpose, the first switch arrangement (18) and the second switch arrangement (19) respectively have a parallel connection made of multiple switching branches (Z) and, in each switching branch (Z), one of the semiconductor switches (20, 21) is provided with an intrinsic safety fuse (22) switched in series to the contact gap of the semiconductor switch (20, 21).

The invention relates to a converter, a vehicle with the converter according to the invention, and a method for operating the converter. The converter has a DC intermediate circuit, the positive and negative conductors of which are connected to an AC phase voltage conductor via a half-bridge circuit. The half-bridge circuit employs the principle of semiconductor switches.

In the event of a defect on such semiconductor switches, the interruption of the operation of the converter may be required, in order to permit the repair of the semiconductor circuit. However, this is not always possible, for example during the flight of an aircraft, the propeller of which is driven by an electric motor which, in turn, is supplied by the converter. However, in an electrically-powered aircraft of this type, semiconductor switches are exposed to significantly more intensive cosmic radiation. This increases the probability of the failure or destruction of one or more semiconductor switches.

In case of such a defect, the state assumed by a defective semiconductor switch cannot be foreseen. Where an IGBT (insulated gate bipolar transistor), a MOSFET (metal-oxide semiconductor field effect transistor) or a diode is the respective semiconductor switch, the defective semiconductor switch may be conductive or shorted in the case of one fault, and can remain non-conductive or permanently open in the case of another fault. The defective semiconductor switch cannot then be switched to another state by a control signal. For a suitable response to a defective state, very rapid detection and control is required in order, for example, by means of further switches, to isolate any shorted semiconductor switch, which is permanently electrically conductive, from the system. This type of protective device increases the number of components, and occupies more space. Specifically, where contactors or relays are used for the isolation of semiconductor switches, the additional expenditure is undesirably high. However, if no protective measures at all are in place, uncontrolled transient currents may occur in the case of a fault. As a result of the flow of a short-circuit current in a defective semiconductor switch, further semiconductors, and consequently the entire converter, may thus be destroyed.

The object of the invention, during the operation of a converter, is a rapid and effective response to a defect in one of the semiconductors of said converter.

This object is fulfilled by the subject matter of the independent claims. Advantageous further developments of the invention are disclosed by the characteristics of the dependent claims.

The invention comprises a converter with an intermediate circuit for providing a DC voltage between a positive conductor and a negative conductor. The converter moreover comprises at least one phase conductor for receiving and/or outputting an AC voltage. Although the invention is described hereinafter with reference to a single phase conductor, the description also applies to further phase conductors. The phase conductor is connected to the positive conductor and the negative conductor by means of a half-bridge circuit. The half-bridge circuit has a first switch arrangement for connecting the positive conductor to the phase conductor, and a second switch arrangement for connecting the negative conductor to the phase conductor. These switch arrangements are also described as “high-side” and “low-side”. In a manner which is known per se, by the alternating switching-in of the first switch arrangement and the second switch arrangement, an AC voltage received can be rectified, or an AC voltage can be generated and output on the phase conductor from the DC voltage on the intermediate circuit.

In order to permit the continuing safe operation of the converter notwithstanding a defective semiconductor switch in the half-bridge circuit, the invention provides that the first switch arrangement and the second switch arrangement respectively have a parallel circuit composed of multiple switching branches wherein, in each switching branch, a semiconductor switch is provided with an intrinsic safety fuse, which is series-connected to the contact gap of the semiconductor switch. If the converter has a plurality of phase conductors, each phase conductor is correspondingly connected to the positive conductor and the negative conductor via a half-bridge circuit of the aforementioned type.

The invention has an advantage in that a defective semiconductor switch which is shorted, i.e. is permanently and/or uncontrollably electrically conductive, is switched-out by the safety fuse of the defective semiconductor switch, wherein the safety fuse blows as soon as a short-circuit current flows in the defective semiconductor switch. The converter can then continue operating with the remaining semiconductor switches in the at least one parallel switching branch. Tripping of the safety fuse does not even require the detection of the defective semiconductor switch.

In the converter according to the invention, each semiconductor switch can be configured, for example, according to the principle of an IGBT, a MOSFET or a diode. In the aforementioned semiconductor switches, the contact gap is the drain-source path or the collector-emitter path.

The converter according to the invention is specifically a 2-level converter.

The invention encompasses further developments, the characteristics of which deliver additional advantages.

According to one further development, a control device of the converter is designed such that, in each of the switch arrangements, the respective control inputs of the semiconductor switches, i.e. the respective gate or base, are controlled simultaneously. This has an advantage in that, in the case of a defect on one of the semiconductor switches, the uninterrupted operation of the converter can continue, using the remaining semiconductor switches.

As indicated above, the half-bridge circuit can be used to rectify an AC voltage, or to convert a DC voltage on the intermediate circuit into an AC voltage. To this end, the first and second switch arrangements must be switched-in alternately. Accordingly, it is thus ensured that the first switch arrangement and the second switch arrangement are switched to an electrically conductive state in different time intervals. If one of the semiconductor switches is damaged during one time interval, and is shorted as a result, a short-circuit will be formed between the positive conductor and the negative conductor in the next time interval in which the other switch arrangement is switched-in, thereby tripping the safety fuse of the defective semiconductor switch. In the next time interval in which the first switch arrangement is again switched to the conductive state, the latter can then continue to operate without the defective semiconductor switch.

According to a further development, it is ensured that the safety fuse of the defective semiconductor switch is destroyed by the short-circuit, and not the safety fuses of any semiconductor switches in the other switch arrangement in which the short-circuit current (divided into partial currents) also flows. According to this further development, each safety fuse is designed such that it will only be tripped by a tripping current of a current rating which corresponds to the short-circuit current between the positive conductor and the negative conductor, where this short-circuit current flows exclusively in the safety fuse. This ensures that the safety fuse of the defective semiconductor switch is tripped. In this arrangement of safety fuses, as the short-circuit current in the other switch arrangement is divided between a plurality of semiconductor switches, the safety fuses thereof will not be tripped.

The self-protecting converter according to the invention can be particularly advantageously employed in vehicles as, under certain circumstances, the latter cannot immediately interrupt their journey in the case of a defect on a semiconductor switch.

Accordingly, the invention includes a vehicle with an electric drive motor for the propulsion of the vehicle for the purposes of travel, wherein the drive motor is connected via a converter to an electric generator. The converter thus constitutes one form of embodiment of the converter according to the invention. The vehicle according to the invention has an advantage, in that the travel thereof does not need to be interrupted immediately in the case of a defect on a semiconductor switch.

According to a further development, the vehicle is configured as an aircraft, specifically as a fixed-wing aircraft. In this case, the drive motor propels the propeller of the aircraft or (in the case of a rotary-wing aircraft) a rotor of the aircraft. According to another further development, the vehicle is configured as a motor vehicle, for example a motor car or an HGV. Here again, during the travel of the motor vehicle according to the invention, the drive motor can continue to drive the wheels of the vehicle, even in the event of a defect on one of the semiconductor switches.

According to a further development, the drive motor, the converter and the generator are interconnected, with no contactors. The resulting vehicle is of exceptionally compact and light-weight construction.

A reduction in structural space and weight also gives rise to a further development, wherein the drive motor and the generator have only a single multi-phase winding system respectively. In other words, no redundant three-phase current windings are provided, of the type required, for example, in the parallel operation of two converters, for the purposes of redundancy.

Finally, the invention also comprises a method for the operation of one form of embodiment of the converter according to the invention. By means of the method, a defective semiconductor switch, which is permanently locked in an electrically conductive state, is rendered inoperative. In the operation of the converter, wherein the converter receives a first AC voltage at a predetermined frequency, for example from a generator, and generates a second AC voltage at an adjustable frequency, the method is executed as follows.

On the switch arrangement of the half-bridge circuit, in which the defective semiconductor switch is arranged, a control signal is generated for the opening of all the semiconductor switches. The defective semiconductor switch does not respond to the signal. All the remaining functional semiconductor switches react to the control signal, by switching over to a non-conducting state. On the other switch arrangement of the half-bridge circuit, a signal is generated for the closing of all the semiconductor switches. Accordingly, the positive conductor and the negative conductor of the intermediate circuit are short-circuited on one side by the defective semiconductor switch, and on the other side by at least two semiconductor switches on the other switch arrangement. As a result, a short-circuit current flows between the positive conductor and the negative conductor, wherein the full short-circuit current flows through the defective semiconductor switch. In the other switch arrangement, the short-circuit current is divided between at least two further semiconductor switches. As a result, the safety fuse of the defective semiconductor switch is tripped. The method is executed automatically during the operation of the converter, with no requirement for detecting the defective semiconductor switch.

The invention also encompasses further developments of the method according to the invention, incorporating characteristics which have already been described in conjunction with further developments of the converter according to the invention. For this reason, corresponding further developments of the method according to the invention will not be described again here.

An exemplary embodiment of the invention is described hereinafter. To this end:

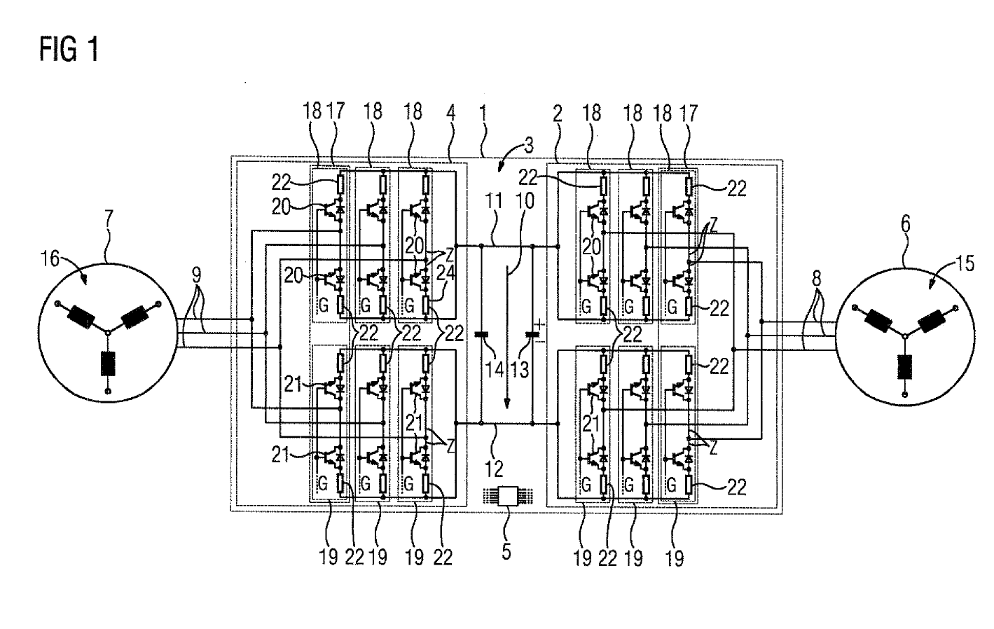

FIG. 1 shows a schematic representation of one form of embodiment of the converter according to the invention,

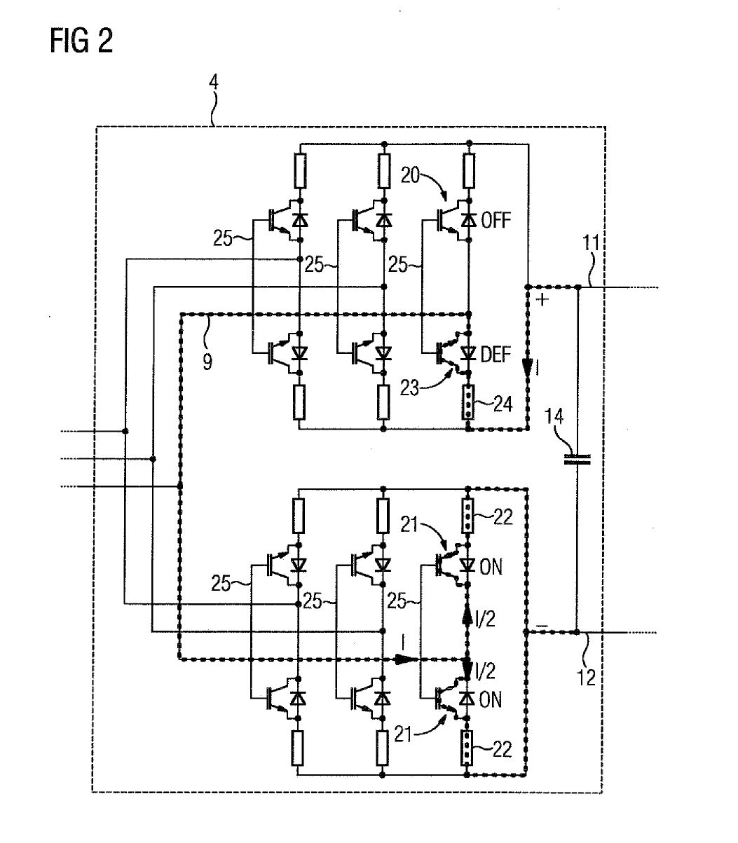

FIG. 2 shows a schematic representation of part of the converter from FIG. 1 during the execution of one form of embodiment of the method according to the invention, and

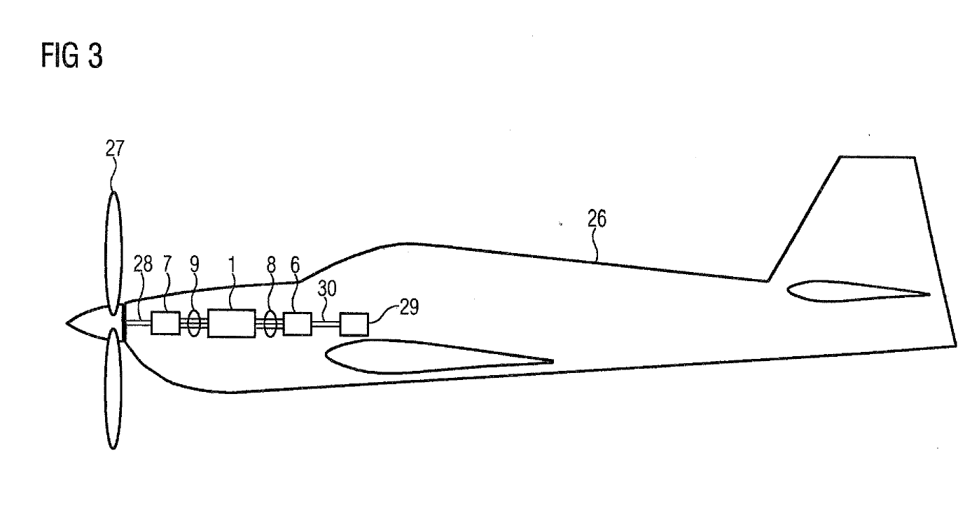

FIG. 3 shows a schematic representation of one form of embodiment of the vehicle according to the invention.

The exemplary embodiment described hereinafter is a preferred form of embodiment of the invention. In the exemplary embodiment, the component elements of the form of embodiment described each constitute individual and mutually independent characteristics of the invention, which further develop the invention in a mutually independent manner, and are thus to be considered as a constituent element of the invention, whether independently or in a combination other than that described. Moreover, the form of embodiment described can also be supplemented by further characteristics of the invention, as described heretofore.

In the Figures, elements of equivalent function are designated by the same reference symbols in each case.

FIG. 1 shows a converter 1, which comprises a rectifier 2, an intermediate circuit 3, an inverter 4 and a control unit 5. By means of the converter 1, a voltage source 6 (for example, an electric generator) and an electrical consumer 7 (for example, an electric motor) can be mutually coupled. The voltage source 6 can be connected to the rectifier 2 by means of phase conductors 8. The consumer 7 can be connected to the inverter 4 by means of phase conductors 9. The phase conductors 8, 9 respectively can transmit AC voltages of different phases.

From the AC voltages on the phase conductors 8, the rectifier 2 can generate a DC voltage 10, which is fed into the intermediate circuit 3. The intermediate circuit 3 can comprise a positive conductor 11 and a negative conductor 12, between which the DC voltage 10 is applied. The positive conductor 11 and the negative conductor 13 can be coupled via a battery 13 and an intermediate circuit capacitor 14, by means of which an intermediate circuit capacitance C is delivered. The positive conductor 11 and the negative conductor 12 couple the rectifier 2 and the inverter 4 respectively. The positive conductor 11, the negative conductor 12 and the phase conductors 8, 9 can be configured, for example, in the form of a wire or a conductor rail respectively.

During the operation of the converter 1, the converter 1 converts the AC voltages on the phase conductors 8 into AC voltages, which are delivered to the consumer 7 via the phase conductors 9.

The converter 1 is configured as a redundant converter, for the purposes of defect protection. As a generator, the voltage source 6 nevertheless requires only a single generator winding system 15 in the stator. As an electrical machine, the consumer 7 requires only a single motor winding system 16 in the stator. In the event of a defect, no switchover of the power flux by means of contactors is required. Redundancy can also be provided by means of an individual intermediate circuit capacitor 14 and an individual battery 13.

The rectifier 2 and the inverter 4 each comprise half-bridges 17, each of which connects or bonds the positive conductor 12 and the negative conductor 13 respectively to one of the other phase conductors 9. In the interests of clarity, only three of the half-bridges are marked with reference symbols.

Each half-bridge 17 can comprise two switch arrangements 18, 19. The switch arrangement 18 and the switch arrangement 19 are also designated as the high-side circuit and the low-side circuit respectively. In each half-bridge 17, the switch arrangement 18 connects the positive conductor 12 to the respective phase conductor 9. The switch arrangement 19 connects the negative conductor 13 to the same phase conductor 9. By the alternating switching-in of the switch arrangements 18, 19 in the rectifier 2, a DC voltage 10 is generated from an AC voltage on one of the phase conductors 8, in a known manner. By the alternating switching-in of the switch arrangements 18, 19 in the inverter 4, an AC voltage is applied or generated respectively in one of the phase conductors 9, from the DC voltage 10, in a known manner.

For the control of the switch arrangements 18, 19 on the half-bridge 17, control terminals G on the switch arrangements 18, 29 can be coupled to the control device 5. The control device 5 can be partially or entirely integrated in the switch arrangements 18, 19. It can be partially or entirely configured as a separate control unit.

The rectifier 2 and the inverter 4 can incorporate the same circuit topology, i.e. they can be configured to an identical design.

For the achievement of the aforementioned redundancy, in the rectifier 2 and the inverter 4, the switch arrangements 18, 19 each comprise a plurality of semiconductor switches 20, 21. Each semiconductor switch 20, 21 is connected in series with a dedicated safety fuse 22. In each switch arrangement 18, 19, a parallel circuit composed of a plurality of series circuits or switching branches Z is thus provided, wherein each switching branch Z is configured on the basis of a semiconductor switch 20, 21 and a safety fuse 22. Each semiconductor switch 20, 21 can be configured, for example, as an IGBT or MOSFET.

For the further clarification of the exemplary embodiment, reference will be made to FIG. 2, wherein it is assumed that one of the semiconductor switches 20 in the inverter 4 is defective. The defective semiconductor switch 20 is designated hereinafter as the defective semiconductor switch 23. As a result of the defect, the defective semiconductor switch 23 is fully electrically conductive, i.e. in the example represented, the positive conductor 12 is permanently electrically bonded with one phase conductor 9or short-circuited.

In the converter 1, as a result of the topology thereof, a method proceeds whereby the safety fuse 24 which is associated with the defective semiconductor switch 23 is tripped or melted, such that electrical separation or electrical isolation is effected by means of the safety fuse 24. In the example shown, the positive conductor 12 can thus be electrically isolated from the phase conductor 9, although the defective semiconductor switch 23 remains permanently electrically conductive. Any detection of the defective semiconductor 23 can be omitted.

In this method, by the switching-in of the non-defective semiconductor switch 21, i.e. the semiconductor switch in that switch arrangement 19 in which the defective semiconductor switch 23 is not located, the defective semiconductor switch 23 is isolated from the intermediate circuit 3 by its fuse 24.

By the closing of the semiconductor switch 21, i.e. by the switching of the semiconductor switch 21 to the electrically conductive state (ON), the positive conductor 12 is connected to the negative conductor 13 via the defective semiconductor switch 23, in a permanently conductive state (DEF) on one side, and the semiconductor switch 21 is electrically short-circuited on the other side. A short-circuit current I flows therein.

The remaining semiconductor switches 20 in the switch arrangement 18 in which the defective semiconductor switch 23 is located are switched to an electrically blocking state (OFF), i.e. an open state. Consequently, the full short-circuit current I is routed though the safety fuse 24 and the defective semiconductor switch 23. In the switch arrangement 19, the short-circuit current I is divided on the semiconductor switch 21 to form a partial current I/2. The blowing or tripping of the safety fuses 22 thereof is prevented accordingly.

The safety fuses 22 of each semiconductor switch 20, 21 are thus rated, not for the nominal current, but for the short-circuit current I. In order to ensure that the short-circuit current I is divided on the two semiconductor switches 21 as a partial current I/2, the semiconductor switches 21 are controlled simultaneously. To this end, the semiconductor switches 21 and the semiconductor switch 20, via their respective control terminals, i.e. their gate or base, are interconnected by means of a common control line 25. By means of outlet points on the control terminals G, and corresponding outlet points on the control device 5, FIG. 1 indicates how each of the control lines 25 is controlled by the control device 5.

In the event of a defective semiconductor switch 23, the normal operation of the converter 1 will continue. The defective (shorted) semiconductor switch 23 connects the positive point of the intermediate circuit voltage 10 to one phase conductor 9. If the semiconductor switches 21, which conduct the negative point of the negative conductor 12 to the same phase conductor 9, are now actuated, a dead short of the intermediate circuit voltage 10 will occur. The short-circuit current I will be divided between the two switched-in semiconductor switches 21 and their safety fuses 22. However, the full short-circuit current I flows in the defective (shorted) semiconductor switch 23 and its safety fuse 24, which is tripped as a result. The defective semiconductor switch 23 is thus deactivated, i.e. its switching branch Z is in an electrically non-conductive, open state. The semiconductor switches 20 which are connected in parallel to the defective semiconductor switch 23 (in the example, only one further semiconductor switch 20 is parallel-connected) continue to switch the proportion of the intermediate circuit voltage.

In addition to an electrically-propelled aircraft (ePlane), applications include an electrically-powered motor vehicle (eCar) and a drive converter for the fulfilment of a higher redundancy requirement and/or SIL (SIL: safety integrity level in accordance with international standards IEC 61508/IEC 61511).

FIG. 3 illustrates the provision of the converter 1, for example in an aircraft 26. Rather than in an aircraft 26, the converter can also be provided in another vehicle, e.g. a motor vehicle.

FIG. 3 shows a fixed-wing aircraft 26, in which a propeller 27 can be driven by the consumer 7. The propeller 27 is rotated by the consumer 7 on a shaft 28. In the example illustrated, the consumer 7 is an electric drive motor, i.e. an electrical machine which is operated as a motor. The energy for the propulsion of the propeller 27 can be obtained from a combustion engine 29, which may be, for example, an Otto engine or a diesel engine. Via a shaft 30, the combustion engine 29 can power the voltage source 6 which, to this end, is configured as an electric generator. An electric generator can be provided in the form of an electrical machine operating in generator mode. The speed of rotation of the shaft 30 is independent of the speed of rotation of the shaft 28. The AC voltage generated from the voltage source 6, in the manner described, can thus be converted by means of the converter 1 into an AC voltage, which can be supplied via the AC voltage phase conductors 9 to the consumer 7. A switching frequency of the switch arrangements 18, 19 is set accordingly by the control unit 5, in relation to a target speed of the propeller 27. To this end, the target speed can be set or predetermined, for example by the pilot, by means of a control element (not represented).

Overall, this example illustrates the provision of a 2-level converter with fuse protection according to the invention.

### LIST OF REFERENCE SYMBOLS

1 Converter
2 Rectifier
3 Intermediate circuit
4 Inverter
5 Control device
6 Voltage source
7 Consumer
8, 9 Phase conductor
10 DC voltage
11 Positive conductor
12 Negative conductor
13 Battery
14 Intermediate circuit capacitor
15 Generator winding system
16 Motor winding system
17 Half-bridges
18, 19 Switch arrangement
20, 21 Semiconductor switch
22 Safety fuse
23 Defective semiconductor switch
24 Safety fuse
25 Control line
26 Aircraft
27 Propeller
28 Shaft
29 Combustion engine
30 Shaft
G Control terminal
I Short-circuit current
I/2 Partial current
Z Switching branch

1-10. (canceled)

11. A converter, comprising:
an intermediate circuit configured to provide a DC voltage between a positive conductor and a negative conductor;
a phase conductor receiving and/or outputting an AC voltage; and
a half-bridge circuit having a first switch arrangement connecting the positive conductor to the phase conductor, and a second switch arrangement connecting the negative conductor to the phase conductor, each of the first and second switch arrangements having a parallel circuit composed of multiple switching branches, wherein, in each switching branch, a semiconductor switch is provided with an intrinsic safety fuse which is series-connected to the contact gap of the semiconductor switch.

12. The converter of claim 11, further comprising a control device constructed so that, in each of the switch arrangements respective ones of control inputs of the semiconductor switches are controlled simultaneously.

13. The converter of claim 12, wherein the control device is configured so that it generates AC voltage from DC voltage, or generates DC voltage from AC voltage, to switch the first switch arrangement and the second switch arrangement to an electrically conductive state at different time intervals.

14. The converter of claim 11, wherein each of the semiconductor switches is configured respectively as a semiconductor switch selected from the group consisting of an IGBT, a MOSFET, and a diode.

15. The converter of claim 11, wherein each of the safety fuses is configured such that it will only be tripped by a tripping current of a current rating which corresponds to a short-circuit current between the positive conductor and the negative conductor, where the short-circuit current flows exclusively in the safety fuse.

16. A vehicle, comprising:
an electric drive motor for propulsion of the vehicle for the purposes of travel;
an electric generator; and
a converter configured to connect the drive motor to the electric generator, said converter including an intermediate circuit configured to provide a DC voltage between a positive conductor and a negative conductor, a phase conductor receiving and/or outputting an AC voltage, and a half-bridge circuit having a first switch arrangement connecting the positive conductor to the phase conductor, and a second switch arrangement connecting the negative conductor to the phase conductor, each of the first and second switch arrangements having a parallel circuit composed of multiple switching branches, wherein, in each switching branch, a semiconductor switch is provided with an intrinsic safety fuse which is series-connected to the contact gap of the semiconductor switch.

17. The vehicle of claim 16, wherein the drive motor, the converter and the generator are interconnected in the absence of any contactors.

18. The vehicle of claim 16, wherein the drive motor and the generator have each only a single multi-phase winding system.

19. The vehicle of claim 16, constructed in the form of an aircraft or a motor vehicle.

20. The vehicle of claim 16, constructed in the form of a fixed-wing aircraft.

21. A method of operating a converter by means of which a defective semiconductor switch , which is permanently locked in an electrically conductive state(DEF), is rendered inoperative, and the converter comprises an intermediate circuit providing a DC voltage between a positive conductor and a negative conductor, a phase conductor receiving and/or outputting an AC voltage, a half-bridge circuit having a first switch arrangement connecting the positive conductor to the phase conductor and a second switch arrangement connecting the negative conductor to the phase conductor, with the first switch arrangement and the second switch arrangement respectively having a parallel circuit composed of multiple switching branches, and with each switching branch having a semiconductor switch with an intrinsic safety fuse which is series-connected to the contact gap of the semiconductor switch, said method comprising:
in operation of the converter, wherein the latter receives a first AC voltage at a predetermined frequency, and generates a second AC voltage at an adjustable frequency, on the first switch arrangement in which the defective semiconductor switch is arranged, generating a control signal for opening of all the semiconductor switches, and on the second switch arrangement of the same half-bridge circuit, generating a control signal for closing of all the semiconductor switches, such that the positive conductor and the negative conductor of the intermediate circuit are short-circuited by the defective semiconductor switch and by at least two semiconductor switches on the other switch arrangement, and thereby the safety fuse of the defective semiconductor switch is tripped.
